(19) United States
(12) Patent Application Publication
(10) Pub. No.: US 2026/0290708 A1
(43) Pub. Date: Sep. 24, 2026

(54) COAXIAL CAPACITOR TOPOLOGY FOR REDUCED EQUIVALENT SERIES RESISTANCE AND EQUIVALENT SERIES INDUCTANCE

(71) Applicants: VIRGINIA TECH INTELLECTUAL PROPERTIES, INC., Blacksburg, VA (US); University of Connecticut, Farmington, CT (US)

(72) Inventors: Yang Cao, Glastonbury, CT (US); Ning Guo, Manchester, CT (US); Jierui Zhou, Schenectady, NY (US); Wesley Zhong, Tolland, CT (US); Mark Cairnie, Orwigsburg, PA (US); Christina DiMarino, Arlington, VA (US)

(21) Appl. No.: 19/694,403

(22) Filed: Jun. 1, 2026

Related U.S. Application Data
(63) Continuation-in-part of application No. 19/309,177, filed on Aug. 25, 2025.
(60) Provisional application No. 63/711,846, filed on Oct. 25, 2024.
(60) Provisional application No. 63/814,963, filed on May 30, 2025.

(51) Int. Cl. H01G 4/38; H01G 4/228; H01G 4/33

(52) U.S. Cl. CPC H01G 4/38; H01G 4/228; H01G 4/33

(57) ABSTRACT

A coaxial capacitor array can include a plurality of capacitors arranged in at least one concentric ring around a longitudinal axis, an inner conductive element positioned at a center of the at least one concentric ring and electrically connected to first terminals of the plurality of capacitors, and an outer conductive element positioned around an outer periphery of the at least one concentric ring and electrically connected to second terminals of the plurality of capacitors. The concentric arrangement can produce opposing currents in the inner and outer conductive elements that generate magnetic fields that substantially cancel, resulting in ultra-low equivalent series inductance at high frequency. The coaxial capacitor array can be implemented in a coaxial cell of a power converter along with a coaxial semiconductor package and a coaxial inductor module for voltage conversion.

### CROSS-REFERENCE TO RELATED APPLICATIONS

This application is a continuation-in-part of U.S. patent application Ser. No. 19/309,177, which claims the benefit of and priority to U.S. Provisional Patent Application No. 63/711,846, filed Oct. 25, 2024, entitled “CABLE-INTEGRATED COAXIAL POWER CONVERTER,” the entire contents of both of which are hereby incorporated herein by reference in their entirety. This application also claims the benefit of and priority to U.S. Provisional Patent Application No. 63/814,963, filed May 30, 2025, entitled “A COAXIAL CAPACITOR TOPOLOGY FOR REDUCED EQUIVALENT SERIES RESISTANCE AND EQUIVALENT SERIES INDUCTANCE,” the entire content of which is hereby incorporated herein by reference in its entirety.

### STATEMENT REGARDING FEDERALLY SPONSORED RESEARCH OR DEVELOPMENT

This invention was made with government support under grant number DE-AR0001568, awarded by ARPA-E. The government has certain rights in the invention.

### BACKGROUND

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

Power converters are used in substations where they help manage and distribute electrical energy efficiently across various parts of the grid. These power converters may need large transformers, heat sinks, cooling systems, and protective enclosures, leading to considerable space usage in a substation. The need for extensive cooling systems and large physical space can have environmental impacts in terms of land usage and energy consumption.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts an example power distribution system according to one or more embodiments of the present disclosure.

FIG. 2 depicts an example implementation of the power converter shown in the power distribution system of FIG. 1, according to one or more embodiments of the present disclosure.

FIG. 3 depicts a side view of an example implementation of a cell that can be implemented in the power converter shown in FIG. 2, according to one or more embodiments of the present disclosure.

FIG. 4 depicts a perspective view of an example implementation of a coaxial semiconductor package that can be used in the cell shown in FIG. 3 according to one or more embodiments of the present disclosure.

FIG. 5 depicts a perspective view of a switch package in the coaxial semiconductor package shown in FIG. 4 according to one or more embodiments of the present disclosure.

FIG. 6 depicts an exploded view of the coaxial semiconductor package shown in FIG. 4 according to one or more embodiments of the present disclosure.

FIG. 7 depicts a perspective view of another example implementation of a coaxial semiconductor package that can be used in the cell shown in FIG. 3 according to one or more embodiments of the present disclosure.

FIG. 8 depicts an input semiconductor package of the coaxial semiconductor package shown in FIG. 7 according to one or more embodiments of the present disclosure.

FIG. 9 depicts an output semiconductor package of the coaxial semiconductor package shown in FIG. 7 according to one or more embodiments of the present disclosure.

FIGS. 10A-10E depict views of a coaxial capacitor array and parts thereof that can be implemented in the cell shown in FIG. 3, according to various embodiments of the present disclosure.

FIG. 11 depicts a portion of the power converter shown in FIG. 1 according to one or more embodiments of the present disclosure.

FIG. 12 depicts a portion of a cooling structure of the power converter shown in FIG. 2 according to one or more embodiments of the present disclosure.

FIG. 13A depicts a cell-level schematic of a cell implemented in a coaxial power converter according to one or more embodiments of the present disclosure.

FIG. 13B depicts an overlayed schematic including the cell-level schematic overlayed with a circuit schematic, according to one or more embodiments of the present disclosure.

FIG. 14A depicts heat flow distribution from a cell of a coaxial power converter according to one or more embodiments of the present disclosure.

FIG. 14B depicts a cascaded cell schematic of a coaxial power converter according to one or more embodiments of the present disclosure.

### DETAILED DESCRIPTION

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

Power converters used in substations tend to be bulky. The size of the power converters can be attributed to the need for large transformers, heat sinks, cooling systems, and protective enclosures, among others. In high-power applications, the power converters can take up considerable space in a substation and may need external cooling solutions. The size of the power converters is generally dictated by the power they need to handle, the cooling requirements, and the insulation needed to manage high voltages safely. However, these power converters are essential for the functioning of various distributive systems such as energy storage systems, AC load systems, electric vehicle (EV) charging systems, and other types of distributive systems that receive power from substations.

In the future, electrical grids will likely undergo a transformative evolution, driven by electrification, distributed renewables, and the adoption of medium voltage DC (MVDC) technology. Electrification will extend beyond traditional sectors like transportation to encompass heating and industrial processes, increasing demand. Distributed renewables, such as solar panels and wind turbines, will decentralize power generation, reducing reliance on centralized power plants and enhancing resilience. MVDC, with its efficiency advantages over AC, will facilitate long-distance transmission, integration of renewables, and grid stability. These advancements will enable smarter, more flexible grids capable of balancing fluctuating supply and demand while reducing greenhouse gas emissions. Key initiatives include the integration of smart grid technologies, deployment of advanced metering infrastructure, and implementation of grid automation and control systems. These efforts aim to enhance grid reliability, efficiency, and resilience while accommodating the growing penetration of renewable energy sources and electric vehicles (EVs). Furthermore, the adoption of energy storage solutions and demand response programs enables better management of peak loads and promotes grid flexibility.

Amidst this transformation, power electronics has seen further penetration into the grid, offering numerous advantages, including enhanced grid stability through fast response times and voltage regulation, increased efficiency leading to reduced energy losses, and improved integration of renewable energy sources. Power electronics also support grid stabilization and voltage regulation through the deployment of flexible AC transmission systems (FACTS) devices, such as static var compensators (SVCs) and static synchronous compensators (STATCOMs). While the advantages of power electronics are well understood, scaling and manufacturing these systems at the level required for widespread adoption poses several challenges. Notable challenges include, high complexity, high voltage and current handling, thermal management, material selection and sourcing, testing and quality assurance, and scale-up and cost considerations, among others.

Fueled by these challenges, power electronics engineers are investigating new techniques for manufacturing and integrating power electronics assemblies, in an effort to combine multiple components or functions into a single component, saving space, reducing cost, and improving yield. Popular integration topics include multi-chip modules (MCM), which integrate multiple switch devices onto a single substrate or package, simplifying manufacturing of high current systems by making it easier to parallel large numbers of devices. Building on the MCM principle, intelligent power modules (IPMs) have also gained interest, which integrate the switch devices as well as auxiliary functions like gate drivers, sensing, and protection on a single substrate. The principle has recently been extended to include a complete converter, integrating passive components and transformers onto a common substrate creating a dense, modular power converter.

In the context outlined above, various embodiments of the present disclosure are provided to address many of the challenges associated with power electronics associated with the discussion above. The embodiments provide an integration scheme for power electronics based on implementation with MV cables, allowing the embodiments to combine the density of MV cables with the flexibility of modern power electronics into a cohesive structure to enable a green, resilient, and adaptable grid that meets evolving power demands. The embodiments use cascaded, coaxial, and bi-directional power conversion cells to gradually step-up or step-down required voltage levels. The power conversion or converter cells mimic the coaxial structure of MV cables to reduce insulation needs and provide seamless integration with MV cables.

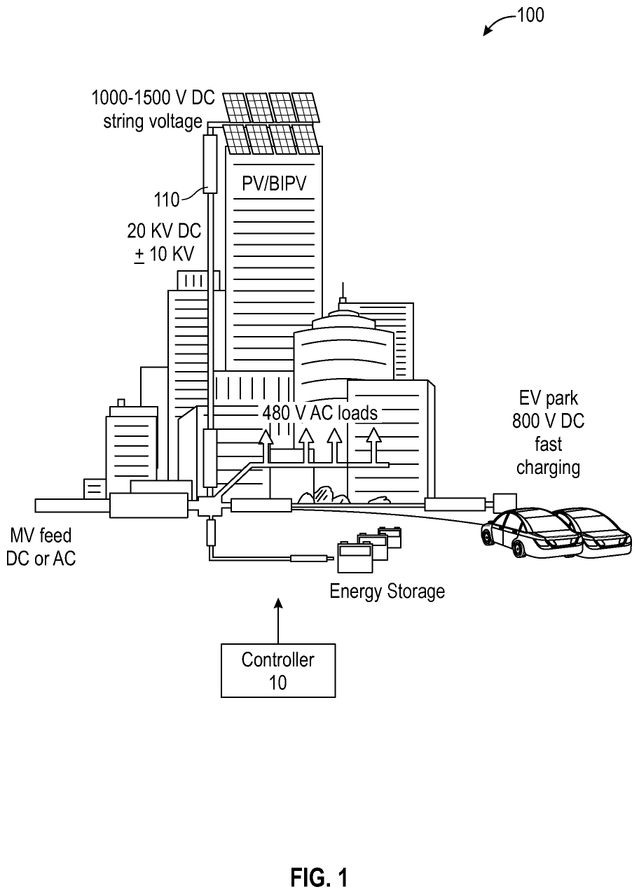

Referring now to the drawings, FIG. 1 depicts an example power distribution system 100 according to one or more embodiments of the present disclosure. The power distribution system 100 includes various sub-distribution systems such as EV charging systems, energy storage systems, and AC distribution systems, which can provide power to one or more loads via a power converter 110. The power converter 110 is a coaxial power converter that can be connected to various types of cables such as MV cables, for converting DC to DC, AC to DC, DC to AC, and AC to AC. The power converter 110 can include one or more cells, which can work together to either step down or step up an input voltage to an output voltage to be suitable for use across various types of loads. For example, the power converter 110 can implement a cascaded configuration across multiple cells to gradually step up or step down to the required voltage levels. The coaxial structure of the power converter 110 reduces insulation needs, provides passive cooling functionality, and provides seamless integration with the power cables connected to the power converter 110.

The power converter 110 can be implemented across various connection points in a substation as depicted in FIG. 1 and be implemented as an intelligent cable splice to splice various types of feeds such as LV-MV and DC-AC, among others. For example, the power converter 110 or one or more of the power converters 110 can be connected between a PV/BIPV (Photovoltaic/Building-Integrated Photovoltaics) source and an AC source, between a DC or AC MV feed and the AC source, between the AC source and an energy storage source, and between the AC source and locations that can provide EV charging. As such, the power converter 110 is compatible with various energy sources such as solar power sources (e.g., PV), wind power sources, hydropower sources, and other types of sources. Further, the power converter 110 is compatible with various types of loads such as EV fast charging, drives, and homes. Target installation points for the power converter 110 include underground cable vaults where ambient temperatures are optimized for free convection at around 50° C. ambient. The power converter 110 is designed to be similar in some aspects to a cable. Thus, it can be more easily deployed to a range of locations (e.g., overhead, buildings, buried, sub-sea, etc.). The power rating of the power converter 110 becomes a function of the environment, much like the power rating of a cable is a function of its environment, i.e., a buried cable in a cold climate can conduct more power than a above ground cable in a dry, arid environment.

A controller 10 can be configured to control operations of the power converter 110. The controller 10 can be configured to generate control signals for the power converter 110 such as pulse width modulation (PWM) control signals, as one example. The controller 10 can also be configured to direct the transfer (and direction) of power through the power converter 110 based on the control signals.

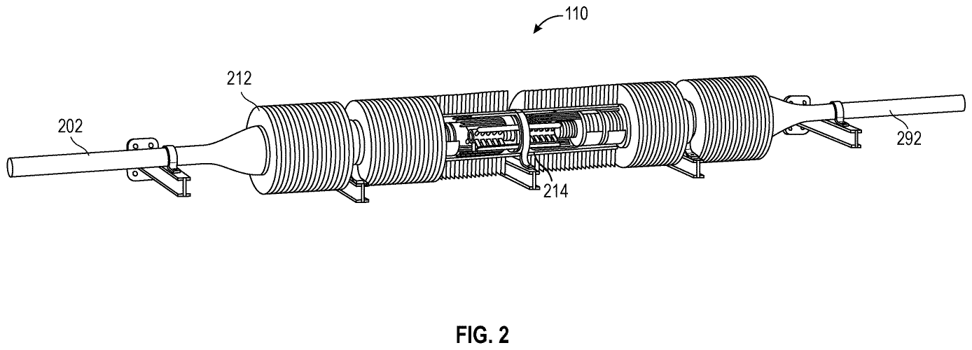

FIG. 2 depicts an example implementation of the power converter 110 shown in the power distribution system 100 according to one or more embodiments of the present disclosure. FIG. 2 is not exhaustively illustrated, meaning that other components not shown in FIG. 2 can be included or relied upon in some cases. Similarly, one or more components shown in FIG. 2 can be omitted in some cases. Additionally, FIG. 2 is not necessarily drawn to any particular scale or size. As depicted, the power converter 110 is connected to an input cable 202 and an output cable 292. The input cable 202 and the output cable 292 correspond to MV cables for example, although other types of cables such as low voltage (LV) cables and high voltage (HV) cables can also be connected to either the input cable 202 or the output cable 292. The power converter 110 can be used to convert DC to DC, AC to DC, DC to AC, and AC to AC, as discussed above, between the input cable 202 and the output cable 292, for feeding various types of loads.

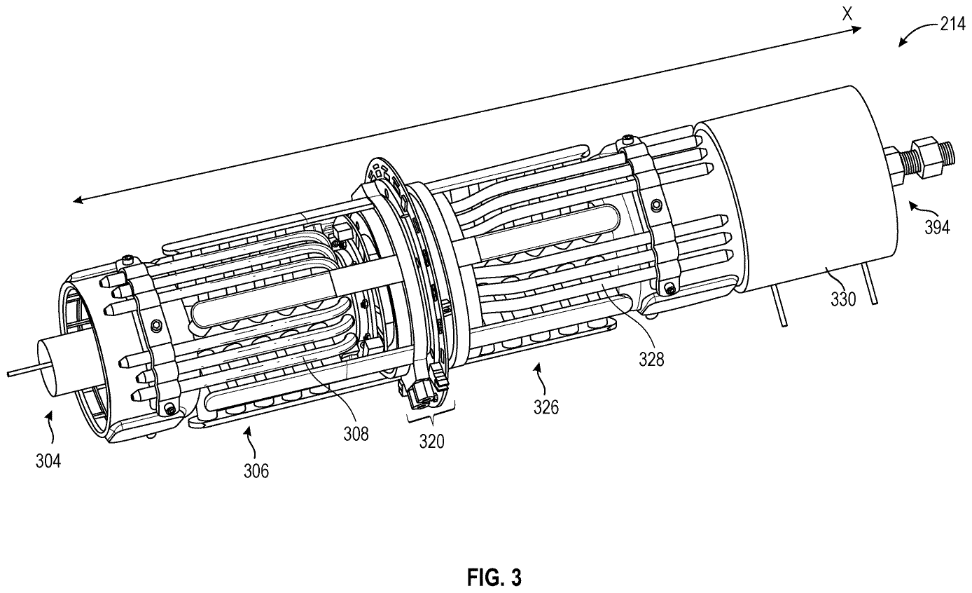

The power converter 110 includes a coaxial cell 214 (“cell 214”) for converting a first voltage to a second voltage. The coaxial cell 214 is generally configured to step down the first voltage to the second voltage but stepping up the first voltage to the second voltage can also be implemented Stepping up the voltage can be achieved by reversing the cell (i.e., the input becomes the output and the output becomes the input). This property of power electronics is referred to as bidirectional power transfer. The coaxial cell 214 includes various components or structures that are each physically structured to be coaxial in shape (e.g., substantially similar to concentric cylinders or coaxial cables). The coaxial cell 214 includes various coaxial components that are arranged therein for converting the first voltage to the second voltage. For example, the coaxial cell 214 includes a coaxial semiconductor package, a coaxial inductor, and multiple coaxial capacitor arrays. The structure and arrangement of these individual components are described further in detail with respect to FIG. 3.

The implementation of the power converter 110 shown in FIG. 2 includes 3 cascaded cells, but the power converter 110 can include greater or fewer than three coaxial cells that are cascaded with one another. In one example, the power converter 110 can include 5 or more cells that are cascaded with one another to increase the conversion ratio from the first voltage to the second voltage. That is, implementation of more cells can depend on the application of the power converter 110 and the type of load and the power requirements that the load commands. As stated previously, power conversion (e.g., step up or step down) can occur gradually across the length of the cells until the required voltage level is met. For example, for a step-down conversion operation, voltage is gradually reduced down the length of the cable until the required voltage level is met.

The power converter 110 includes a passive cooling system, which includes a cooling structure 212 and axial heat pipes on the coaxial cell 214. The cooling structure 212 includes finned tubes that have a radial structure with multiple “fins” that are individually separated by air gaps. The cooling structure 212 can function as a radial heat sink to facilitate dissipation of heat transmitted by the axial heat pipes. The cooling structure 212 has a high thermal-k potting, which provides electrical insulation and cooling for the power converter 110. Although the coaxial cell 214 appears exposed in FIG. 2, the cooling structure 212 is designed to enclose the entirety of the power converter 110 in a uniform manner. The finned tube can include copper or copper alloys.

FIG. 3 depicts a side view of an example implementation of the coaxial cell 214 of the power converter 110. FIG. 3 is not exhaustively illustrated, meaning that other components not shown in FIG. 3 can be included or relied upon in some cases. Similarly, one or more components shown in FIG. 3 can be omitted in some cases. Additionally, FIG. 3 is not necessarily drawn to any particular scale or size. As depicted, the cell 214 includes a first coaxial capacitor array 306 located proximally to an input end 304, a second coaxial capacitor array 326 located proximally to an output end 394, a coaxial semiconductor package or module 320 coupled between the first coaxial capacitor array 306 and the second coaxial capacitor array 326, and a coaxial inductor module 330 coupled to the second coaxial capacitor array 326. The coaxial semiconductor package 320 includes coaxial semiconductor packages 320A and 320B which are described in further detail in the later figures of the present disclosure.

In a configuration that includes only one cell for the power converter 110, the input end 304 can connect directly to the input cable 202, and the output end 394 can connect directly to the output cable 292. In a configuration that includes more than one cell (e.g., a cascaded cell that can include two cells, three cells, four cells, five cells, etc.), the input end 304 and the output end 394 can connect to input or output ends of other respective cells in the arrangement to form a cascaded cell for the power converter 110. A cascaded cell with multiple individual cells can facilitate a higher conversion ratio between an input voltage received from the input cable 202 and an output voltage transmitted via the output cable 292. Additionally, a cascaded cell includes modular properties where one or more cells can be removed from or added to the cascaded cell structure and from the power converter 110 itself, allowing easy installation and removal to facilitate a wide range of applications that require receipt of different voltage levels.

The cell 214 incorporates a substantially coaxial shape (e.g., similar to the shape of concentric cylinders and the cell 214 would fit within a cylinder) for easy integration and implementation with the cables 202 and 292 and also to minimize disturbances to the E-field distribution. The coaxial shape is adopted for each of the coaxial capacitor arrays 306 and 326, the coaxial semiconductor package 320, and the coaxial inductor module 330. The coaxial capacitor arrays 306 and 326, the coaxial semiconductor package 320, and the coaxial inductor module 330 are arranged to form the coaxial cell 214 and extend along a longitudinal axis “X.” In one example, the cell 214 measures approximately 53 cm long with a 13 cm diameter. The cell 214 can be rated for 50 kW with the cooling structure 212 attached and a maximum input voltage of 5 kV according to one example.

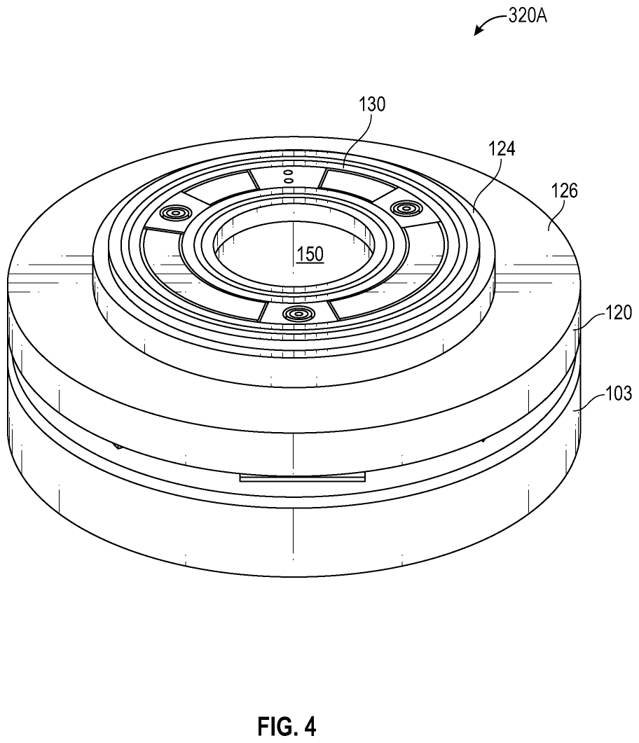

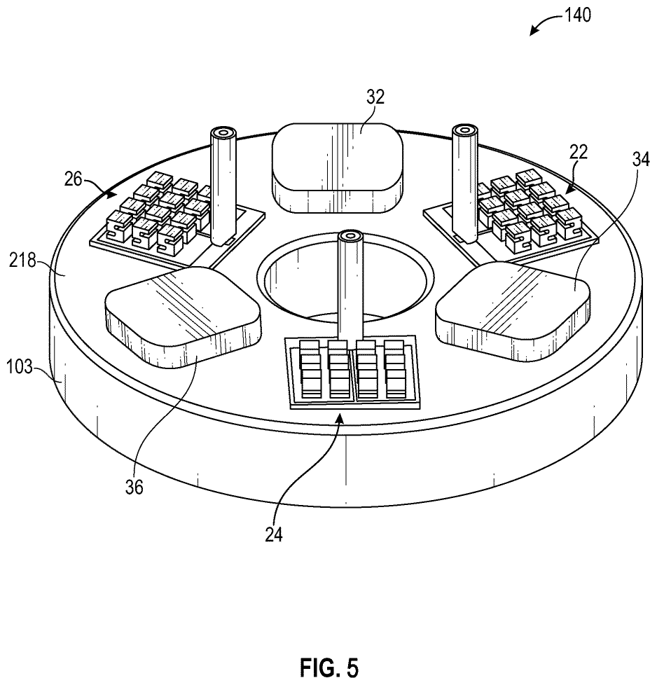

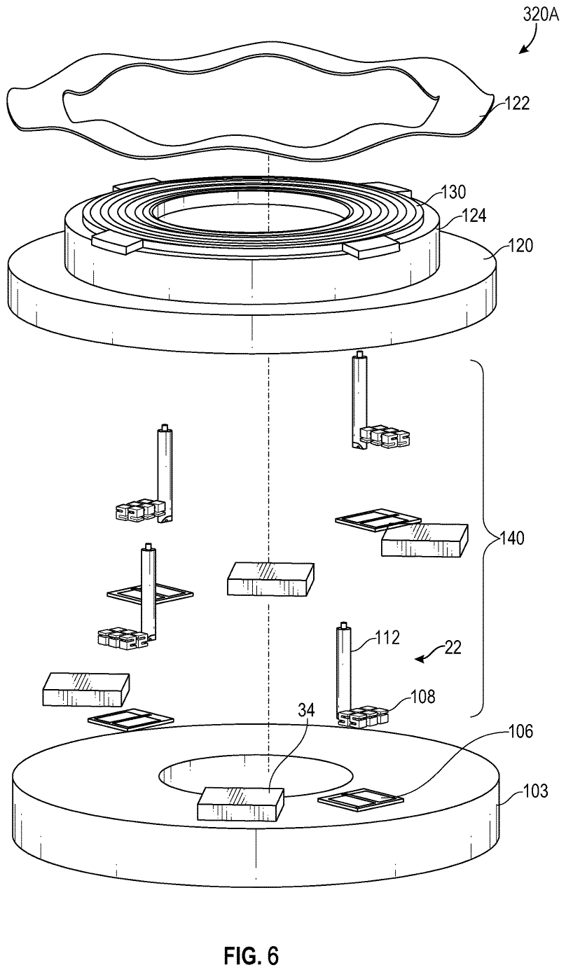

FIG. 4 depicts a perspective view of an example implementation of a coaxial semiconductor package 320A, FIG. 5 depicts a perspective view of a switch package in the coaxial semiconductor package 320A shown in FIG. 4, and FIG. 6 depicts an exploded view of the coaxial semiconductor package 320A shown in FIG. 4, according to one or more embodiments of the present disclosure. The coaxial semiconductor package 320A can be used in the cell 214 and incorporated within MV cables for use in distribution-scale substations, among others, for power distribution and power conversion. Additionally, the coaxial semiconductor package 320A can be used for EV charging and power conversion in renewable energy infrastructure.

The coaxial semiconductor package 320A is not necessarily drawn to any particular scale or size. Additionally, FIGS. 4-6 are not exhaustively illustrated, meaning that other components that are not shown in FIGS. 4-6 can be included or relied upon in some cases. The coaxial semiconductor package 320A includes a first concentric metal contact 103, a second concentric metal contact 120, a printed circuit board (PCB) slip ring 130 on an upper portion 124 of the second concentric metal contact 120, and a wave spring 122 that can also be positioned around the upper portion 124 of the second concentric metal contact 120.

Referring to FIGS. 5 and 6, a switch package 140 can be positioned at the first concentric metal contact 103 and can include individual switch modules 22, 24, and 26 in addition to the second concentric metal contact 120. Although three switch modules 22, 24, and 26 are depicted, greater than or less than three switch modules can be implemented in the coaxial semiconductor package 320A based on power conversion requirements, application for the coaxial semiconductor package 320A, die size of each of the switching transistors of the switch modules 22, 24, and 26, and dimensions of the metal contacts 103 and 120, among other factors. As depicted, the individual switch modules 22, 24, and 26 are arranged concentrically around an upper surface 218 of the concentric metal contact 103. Each switch module 22, 24, or 26 generally includes similar components, such as a die and various interconnects, and these components are described in further detail below.

The switch package 140 can also include spacers 32, 34, and 36, which are arranged concentrically around the upper surface 218. The spacer 32 is arranged between the switch modules 22 and 26, the spacer 34 is arranged between the switch modules 22 and 24, and the spacer 36 is arranged between the switch modules 26 and 24. Each of the spacers 32, 34, and 36 can be used to separate the first concentric metal contact 103 and the second concentric metal contact 120, and to adjust a height between the first concentric metal contact 103 and the second concentric metal contact 120. Each of the spacers 32, 34, and 36 can include AlN, but other materials and compositions can be relied upon.

The spacers 32, 34, and 36 can be substantially rectangular, square-like, or hexagonal in shape. In some cases, the spacers 32, 34, and 36 can include one or more rounded corners. A radius for the rounded corners can be set based on a compromise between reducing the maximum E-field and maximizing a bonding area. In other examples, the spacers 32, 34, and 36 can adopt other shapes more generally such as round, square or square-like, and rectangular or rectangular-like. Additionally, a variety of different metallization schemes can be implemented to facilitate bonding to the spacers 32, 34, and 36. Additionally, the spacers 32, 34, and 36 can include a first silver plated surface as an upper surface and a second silver plated surface as a lower surface or a side surface. Although three spacers 32, 34, and 36 are shown in the provided examples, greater than or less than three spacers may be implemented for the coaxial semiconductor package 320A based on the dimensions and weights of the concentric metal contacts 103 and 120. The spacers 32, 34, and 36 can improve mechanical ruggedness and promote double sided cooling for the coaxial semiconductor package 320A.

To provide a representative example for the switch modules 22, 24, and 26, the switch module 22 can include a switching transistor 106, a metal interconnect 108, and a coaxial gate interconnect 112. The switching transistor 106 can include a source electrically connected to the metal interconnect 108, a drain electrically connected to the first concentric metal contact 103, and a gate electrically connected to the coaxial gate interconnect 112. The gate of the switching transistor 106 can be electrically connected to the coaxial gate interconnect 112 via a center conductor of the coaxial gate interconnect 112. The coaxial gate interconnect 112 can additionally be electrically connected to the source of the switching transistor 106 via an outer conductor of the coaxial gate interconnect 112. The coaxial gate interconnect 112 can also be electrically connected to the source of the switching transistor 106 to form a kelvin source connection for the gate drive signal. The second concentric metal contact 120 can be electrically connected to the source of the switching transistor 106.

The first concentric metal contact 103 and the second concentric metal contact 120 can both include copper-tungsten or other composites including copper. The first concentric metal contact 103 and the second concentric metal contact 120 are shaped differently. For example, the second concentric metal contact 120 is shaped and designed to be equipped with the PCB slip ring 130 and includes the upper portion 124 and a lower portion 126, with the upper portion 124 having a smaller circumference than a circumference of the lower portion 126. The coaxial semiconductor package 320A includes a hollow portion 150 that is configured to allow passthrough. The first concentric metal contact 103 is shaped and designed to house the switch modules 22, 24, and 26 and the spacers 32, 34, and 36. A circumference of the first concentric metal contact 103 is generally the same as the circumference of the lower portion 126 of the second concentric metal contact 120. However, in some embodiments, the circumference of the first concentric metal contact 103 and the circumference of the lower portion 126 of the second concentric metal contact 120 can be different.

A thickness of the first concentric metal contact 103 is generally different from thicknesses of the upper portion 124 and the lower portion 126 of the second concentric metal contact 120. However, the combined thickness of the upper portion 124 and the lower portion 126 may be substantially similar to the thickness of the first concentric metal contact 103. Upon the bonding of the second concentric metal contact 120 to the metal interconnects of the switch modules 22, 24, and 26, the second concentric metal contact 120 can physically contact and compress the metal interconnects (e.g., the metal interconnect 108). The concentric metal contacts 103 and 120 can also include nickel (Ni)—Ag plating in some cases and provide reduced thermo-mechanical stress and reduced peak electric field for the coaxial semiconductor package 320A and provide heat spreading for the coaxial semiconductor package 320A. The switch modules 22, 24, and 26 and the spacers 32, 34, and 36 are symmetrically arranged along a circumferential direction relative to the circumference of the first concentric metal contact 103. For example, distances between each of the three switch modules 22, 24, and 26 are equidistant or substantially similar in the circumferential direction.

The coaxial gate interconnect 112 (and other coaxial gate interconnects of the switch modules 22, 24, and 26) can be concentric and cylindrical in shape. The coaxial gate interconnect 112 can also include anisotropic conductive film (ACF) and/or a molybdenum post. This post could be made from other materials, such as copper. This component could also be described as a socket, adapter, or mount, etc. The post can be relied upon to provide a solder cup or socket for the coaxial gate interconnect to terminate to on one side, while providing a flat surface for bonding to the die on the other side. The coaxial gate interconnect 112 can be configured to connect to a respective gate driver of a power converter system, for driving and controlling switching operations of the switching transistor 106. The coaxial gate interconnect 112 can connect to a respective gate driver via the slip ring 130, which can be configured to function as an interface for the respective gate driver circuitry. The coaxial gate interconnect 112 can include a combination of: various metals and polytetrafluoroethylene (PTFE), various metals and microporous PTFE, glass and Kovar, and/or AL and CTE-matched epoxy. However, the coaxial gate interconnect 112 is not limited thereto. Benefits of the coaxial gate interconnect 112 include its coaxial structure which allows inductance to scale well with length.

As mentioned above, the coaxial semiconductor package 320A can be implemented within MV cables for use in electrical distribution networks such as electrical substations, EV charging systems, and renewable energy infrastructure systems, among other distribution networks. The coaxial semiconductor package 320A can preserve a coaxial structure of the MV cable it may be implemented in, utilize solid insulation instead of air, and distribute heat axially to reduce heat flux. For example, the hollow portion 150 can facilitate installation of an MV cable or other coaxial structure. The coaxial semiconductor package 320A is further equipped with a modular architecture, where one or more components may be added or removed depending on application of the coaxial semiconductor package 320A. The coaxial semiconductor package 320A, via the switch package 140, can facilitate power conversion in a power converter. For example, the coaxial semiconductor package 320A can facilitate direct current (DC)-to-DC conversion, such as from a higher DC voltage at a lower current rating to a lower DC voltage at a higher current rating. Additionally, the coaxial semiconductor package 320A can facilitate bidirectional power conversion for a power converter system in various applications.

The switching transistor 106 can be embodied as a silicon carbide (SiC) metal-oxide-semiconductor-field-effect transistor (MOSFET) preferably for use with MV applications. However, the switching transistor 106 can be embodied as a different type of switch depending on the application of the coaxial semiconductor package 320A. For example, the switching transistor 106 can be embodied as a Si insulated gate bipolar transistor (IGBT), among other types of switching transistors, for use with EV charging systems.

The second concentric metal contact 120 can be equipped with the PCB slip ring 130. In the example shown, the PCB slip ring 130 is substantially fitted within the circumference defined by the upper portion 124 of the second concentric metal contact 120. The PCB slip ring 130 can be designed and configured to receive the coaxial gate interconnects (e.g., the coaxial gate interconnect 112) of the switch modules 22, 24, and 26 through one or more receptacles or ports that may be drilled into the PCB slip ring 130 and the second concentric metal contact 120. The PCB slip ring 130 is substantially concentric in shape and centrically positioned relative to the second concentric metal contact 120. The PCB slip ring 130 can include axially symmetric electrical contacts. The PCB slip ring 130 can include compliant dry mating contacts (e.g., spring pins, fuzz buttons, wavy washers, etc.) in some cases. Additionally, the PCB slip ring 130 can include axially symmetric electric contacts. The PCB slip ring 130 enables blind electrical connections and built-in compliance and is axially symmetric in design.

The wave spring 122 may also be positioned around the upper portion 124 of the second concentric metal contact 120. For example, the wave spring 122 can be substantially fitted around the circumference defined by the upper portion 124 of the second concentric metal contact 120. The wave spring 122 is substantially concentric in design and shape. The wave spring 122 can be used to absorb geometric tolerances, compress drain-side thermal interface material, and provide compressed waves for low contact resistance interface for the coaxial semiconductor package 320A.

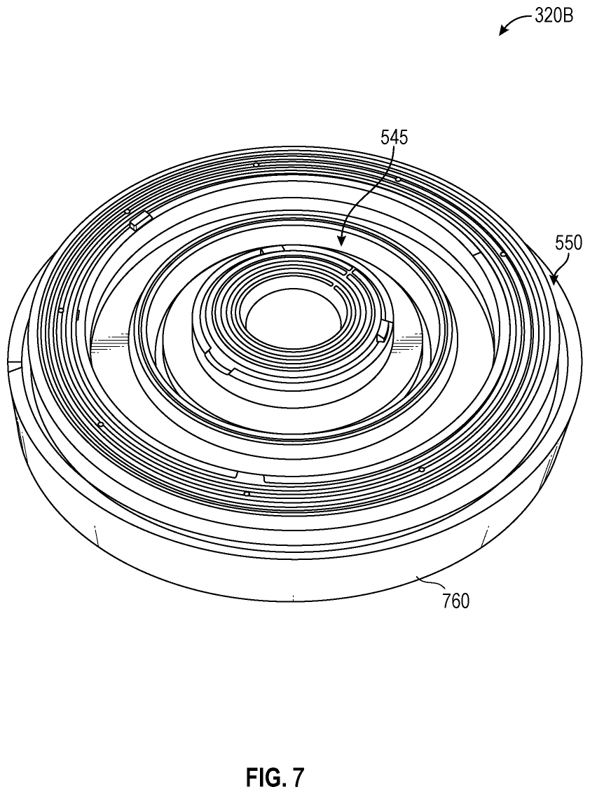

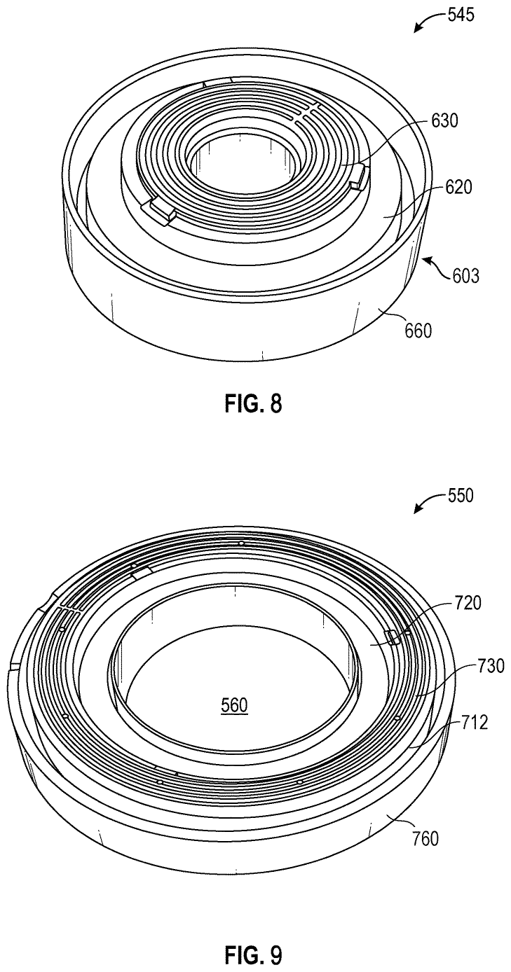

FIG. 7 depicts a perspective view of a coaxial semiconductor package 320B, FIG. 8 depicts an input semiconductor package of the coaxial semiconductor package 320B, and FIG. 9 depicts an output semiconductor package of the coaxial semiconductor package 320B, according to one or more embodiments of the present disclosure. The coaxial semiconductor package 320B is a nested coaxial semiconductor package and can include one or more semiconductor packages nested coaxially in various layers together and can be used in the cell 214 shown in FIG. 3. For example, the coaxial semiconductor package 320B can include an input semiconductor package 545 that is coaxially or concentrically nested within an output semiconductor package 550.

The input semiconductor package 545 is similar to or can generally include the coaxial semiconductor package 320A. For example, the input semiconductor package 545 can include a PCB slip ring 630, a first concentric metal contact 603, and a second concentric metal contact 620, in a similar stacked arrangement as that of the coaxial semiconductor package 320A. The input semiconductor package 545 can include a similar switch arrangement as that shown by the switch package 140, where one or more switch modules can be implemented with the first concentric metal contact 603 (not shown) and a second concentric metal contact 620. A case or protector 660 can be provided around the stacked arrangement of the input semiconductor package 545.

The output semiconductor package 550 includes a similar switch module arrangement or architecture as the input semiconductor package 545 but includes different dimensions for its PCB slip ring 730, first concentric metal contact 712, and second concentric metal contact 720, to accommodate a nested installation of the input semiconductor package 545 within a hollow portion 560. For example, the output semiconductor package 550 can include a similar switch arrangement as that shown by the switch package 140, where one or more switch modules can be implemented with the first concentric metal contact 712 and the second concentric metal contact 720. A case or protector 760 can be provided around the stacked arrangement of the output semiconductor package 550.

The input semiconductor package 545 can be configured to be connected to high voltage potentials as an input-side transistor module in a power converter system such as the cell 214, and the output semiconductor package 550 can be configured to be connected to lower voltage potentials as an output-side transistor module in the power converter system. The above-described features allow voltage distribution in the overall system to replicate that of an MV cable, thus inheriting the voltage scaling properties of MV cables. In one example, the input semiconductor package 545 can be configured to operate at 3.3 kV and 9 mΩ, and the output semiconductor package 550 can be configured to operate at 3.3 kV and 3 mΩ. The coaxial semiconductor package 320B can be used for power conversion applications generally anywhere cables may be used, facilitate intelligent cable splice (e.g., low voltage (LV) to MV, DC to alternating current (AC), etc.), and inherit advantages of various types of cables such as voltage scaling and passive cooling. Further description regarding the coaxial semiconductor package 320 (e.g., including the coaxial semiconductor packages 320A and 320B) can be found in U.S. patent application Ser. No. 19/245,692, which is incorporated herein by reference in its entirety.

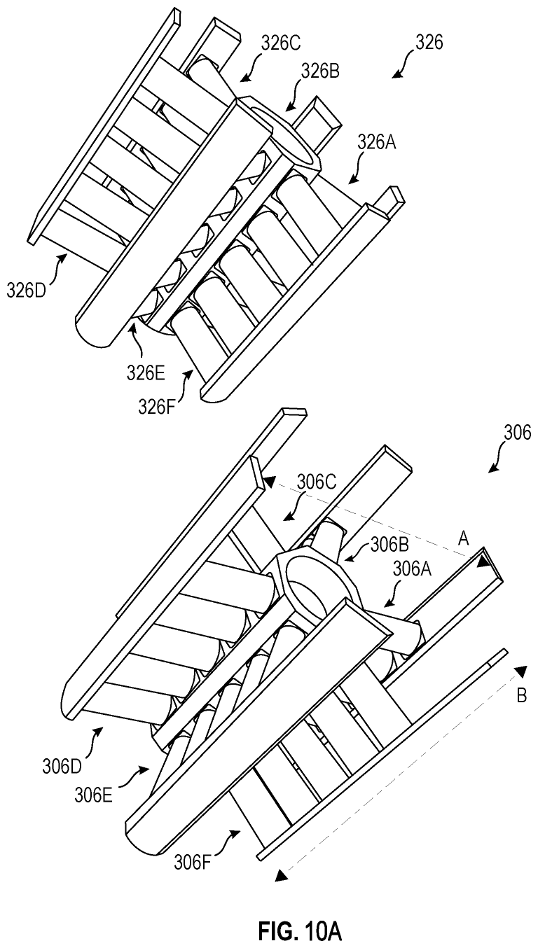

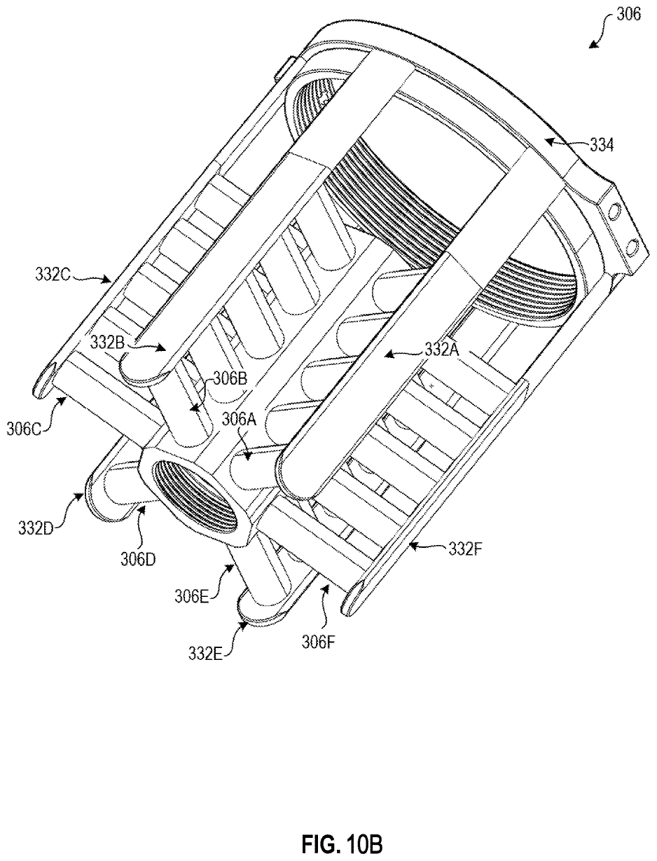

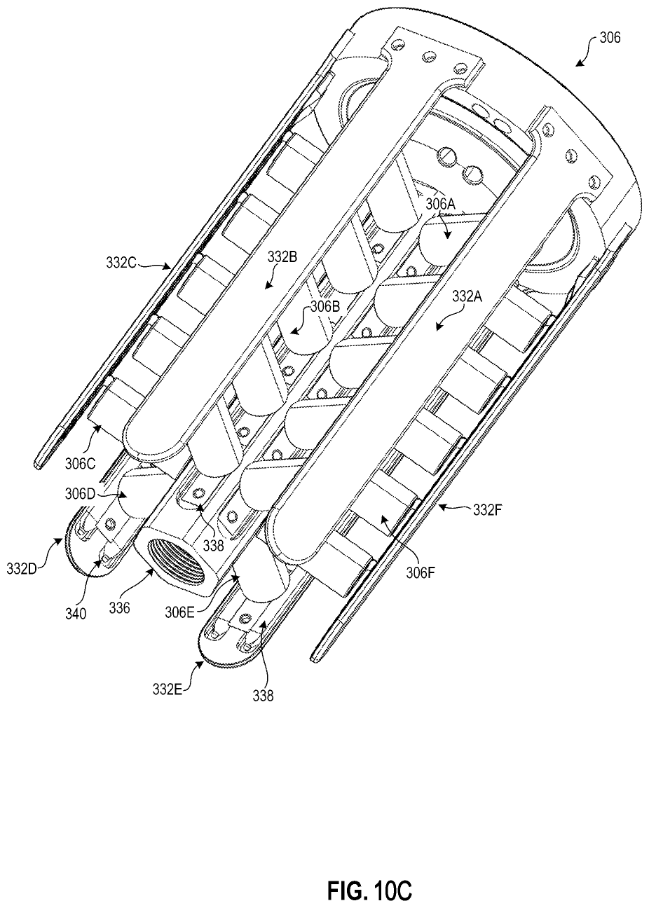

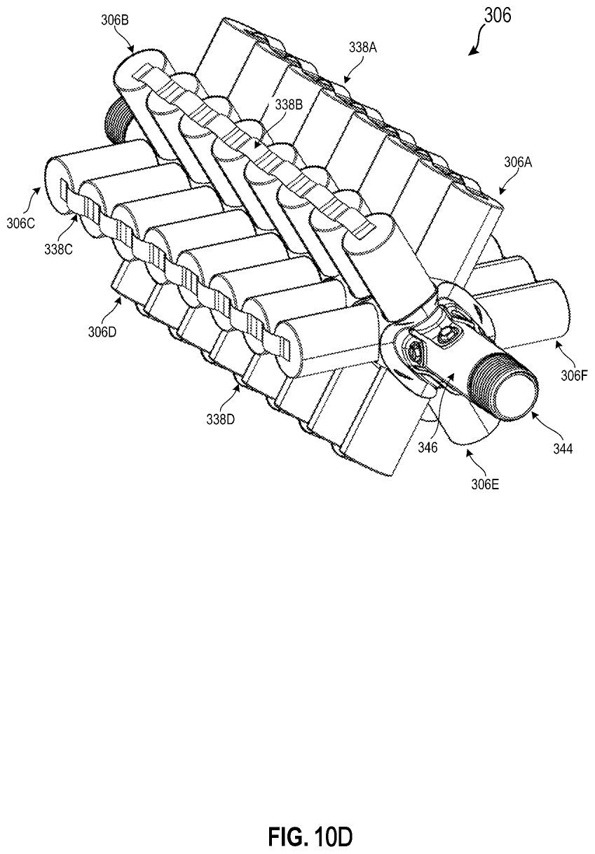

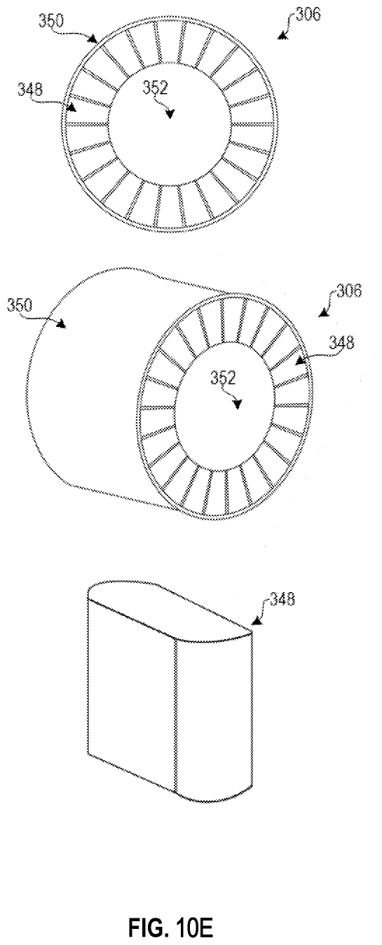

FIG. 10A depicts a perspective view of a coaxial capacitor array that can be implemented in the cell 214, according to one or more embodiments of the present disclosure. Coaxial capacitor arrays 306 and 326 each include multiple rows of individual capacitors. In various examples, each of the coaxial capacitor arrays 306 and 326 can include multiple rows (e.g., 2 rows, 3 rows, 4 rows, 5 rows, 6 rows, etc.) with each row having multiple capacitors. In one example, the first coaxial capacitor array 306 includes a first row 306A, a second row 306B, a third row 306C, a fourth row 306D, a fifth row 306E, and a sixth row 306F, with each row having five individual capacitors. Similarly, the second coaxial capacitor array 326 includes a first row 326A, a second row 326B, a third row 326C, a fourth row 326D, a fifth row 326E, and a sixth row 326F, with each row having five individual capacitors. However, the coaxial capacitor arrays 306 and 326 are not limited thereto and each can include a different arrangement of rows and capacitors in the rows, and the coaxial capacitor arrays 306 and 326 can have a different arrangement or configuration from each other. The multiple rows (306A-306F and 326A-326F) of each coaxial capacitor array 306 and 326 are arranged concentrically to facilitate a coaxial structure for each of the coaxial capacitor arrays 306 and 326 and for minimizing disturbances to the E-field distribution.

In one example, each of the coaxial capacitor arrays 306 and 326 includes 30 discrete and cylindrical polyethylene terephthalate (PET) film or polytherimide (ULTEM™) capacitors that are arranged such that a common MV terminal is at a center of the array while low voltage busbar terminals are arranged around the outer circumference. The capacitors are bonded to Sn-plated terminals via Nanofoil® preform, and the preform bonds the exposed Sn—Zn endspray metallization of the capacitors directly to the Sn-plated busbars without the need for solder and without overheating the capacitor winding. Due to the coaxial structure, magnetic fields caused by opposing currents in the inner and outer conductors can cancel, resulting in very low equivalent series inductance (ESL) at high frequency relative to the size of the capacitor. In one example, each of the coaxial capacitor arrays 306 and 326 can have a cumulative capacitance of 660 nF and a voltage rating of 5 kV. Distances (as indicated by bidirectional arrow A) between opposite rows (e.g., 306A and 306D, 306B and 306E, 326C and 326F, and 326A and 326D, etc.) are equal for the coaxial capacitor arrays 306 and 326. In one example, the distance between opposite rows is 12 cm and a length of an individual row (as indicated by bidirectional arrow B) is 15 cm.

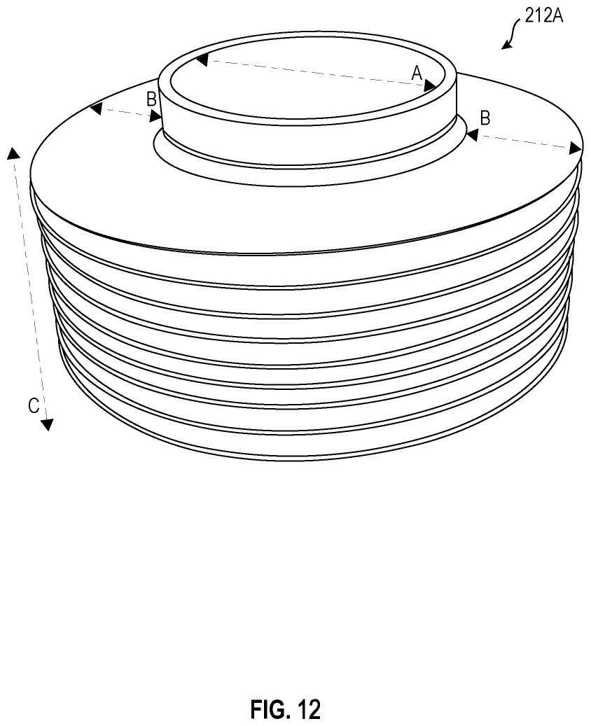

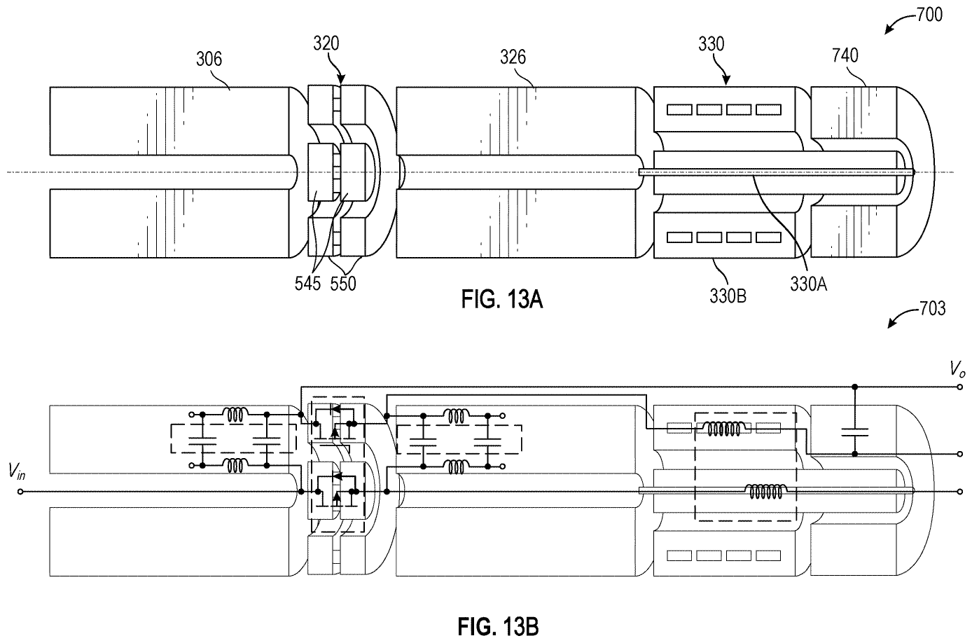

In the various implementations described with respect to FIGS. 10A-10E, individual capacitors within the coaxial capacitor array 306 can have different electrical properties from one another. For example, individual capacitors within a given row (e.g., row 306A) can have different capacitance values, different equivalent series resistance (ESR) values, different voltage ratings, different equivalent series inductance (ESL) values, or different combinations thereof. Similarly, capacitors in different rows (e.g., rows 306A and 306B) can have different electrical properties from capacitors in other rows. In some implementations, capacitors positioned at different radial distances from the longitudinal axis X can have different voltage ratings to accommodate radial voltage grading within the coaxial capacitor array 306, where higher voltage-rated capacitors are positioned nearer to the center of the array and lower voltage-rated capacitors are positioned nearer to the outer periphery, consistent with the radial voltage grading described with respect to FIGS. 13A and 13B. In other implementations, capacitors having different capacitance values can be distributed within the coaxial capacitor array 306 to tailor the frequency response or energy storage characteristics of the array for a particular application. The electrical properties of the individual capacitors can be selected based on the application of the power converter 110, the voltage and current requirements of the cell 214, thermal management considerations, and/or other design criteria.

FIG. 10B depicts a perspective view of another example implementation of a coaxial capacitor array 306 that can be implemented in the cell 214, according to one or more embodiments of the present disclosure. The coaxial capacitor array 306 shown in FIG. 10B includes six rows 306A-306F of film capacitor rolls arranged concentrically, similar to the arrangement described with respect to FIG. 10A. The coaxial capacitor array 306 of FIG. 10B includes outer busbars 332A-332F, where each outer busbar 332A-332F corresponds to a respective row 306A-306F of film capacitor rolls. The coaxial capacitor array 306 of FIG. 10B further includes a collector ring 334 that connects the outer busbars 332A-332F to a common voltage node.

In the implementation shown in FIG. 10B, the film capacitor rolls of the rows 306A-306F are bonded directly to a central mandrel and to the outer busbars 332A-332F via a rigid mechanical bonding process. As a result, the coaxial capacitor array 306 of FIG. 10B forms a rigid, unitary structure that can serve as both an electrical component and a mechanical structural element within the cell 214. For example, the rigid construction of the coaxial capacitor array 306 can provide mechanical support and structural integrity to the cell 214, reducing or eliminating the need for separate mechanical support structures within the cell 214. The collector ring 334 extends around an end of the coaxial capacitor array 306 and electrically connects the outer busbars 332A-332F, thereby establishing a common voltage node at the outer circumference of the coaxial capacitor array 306. Due to the coaxial arrangement of the rows 306A-306F, opposing currents in the central mandrel and the outer busbars 332A-332F produce magnetic fields that substantially cancel, resulting in ultra-low ESL at high frequency, similar to the implementation described above with respect to FIG. 10A.

FIG. 10C depicts a perspective view of another example implementation of the coaxial capacitor array 306 that can be implemented in the cell 214, according to one or more embodiments of the present disclosure. The coaxial capacitor array 306 shown in FIG. 10C includes six rows 306A-306F of film capacitor rolls arranged concentrically around a central mandrel 336, similar to the concentric arrangements described with respect to FIGS. 10A and 10B. The coaxial capacitor array 306 of FIG. 10C includes outer busbars 332A-332F corresponding to the respective rows 306A-306F of film capacitor rolls.

In the implementation shown in FIG. 10C, the film capacitor rolls of the rows 306A-306F are connected to the central mandrel 336 and to the outer busbars 332A-332F via tin ribbons 338 and threaded fasteners. The tin ribbons 338 may be soldered to ends of the film capacitor rolls and fastened to the outer busbars 332A-332F and/or the central mandrel 336 via the threaded fasteners. The tin ribbons 338 provide flexible electrical connections between the film capacitor rolls and the outer busbars 332A-332F, which mechanically decouples forces applied to the coaxial capacitor array 306 from coupling into the film capacitor rolls. This is in contrast to the rigid mechanical bonding described with respect to FIG. 10B, which can transmit mechanical forces directly into the film capacitor rolls. Alternative materials other than tin may be used for the tin ribbons 338.

Mechanical support between the central mandrel 336 and the outer busbars 332A-332F is provided by a potted bushing. The potted bushing provides structural rigidity to the coaxial capacitor array 306 while accommodating the flexible connections provided by the tin ribbons 338.

The coaxial capacitor array 306 of FIG. 10C further includes heat pipes 340 embedded in the outer busbars 332A-332F. The heat pipes 340 extend axially along the outer busbars 332A-332F and provide passive thermal management for the coaxial capacitor array 306. In some implementations, the heat pipes 340 can interface with the axial heat pipe arrays 308 and/or 328 described with respect to FIG. 3 to facilitate heat dissipation along the longitudinal axis X of the cell 214. The coaxial capacitor array 306 of FIG. 10C is physically larger than the implementation described with respect to FIG. 10B. However, due to the concentric arrangement of the rows 306A-306F, the coaxial capacitor array 306 of FIG. 10C achieves substantially similar ultra-low ESL at high frequency as the implementations described with respect to FIGS. 10A and 10B.

FIG. 10D depicts a perspective view of another example implementation of the coaxial capacitor array 306 that can be implemented in the cell 214, according to one or more embodiments of the present disclosure. The coaxial capacitor array 306 shown in FIG. 10D includes six rows 306A-306F of film capacitor rolls arranged concentrically, similar to the concentric arrangements described with respect to FIGS. 10A-10C. The coaxial capacitor array 306 of FIG. 10D is designed for reduced manufacturing cost and scalability relative to the implementations described with respect to FIGS. 10B and 10C.

In the implementation shown in FIG. 10D, the film capacitor rolls of the rows 306A-306F are connected via tin ribbons 338A-338F and threaded fasteners, similar to the connection approach described with respect to FIG. 10C. The tin ribbons 338A-338F may be soldered to ends of the film capacitor rolls and fastened to a threaded pipe 344 (e.g., aluminum) that extends through a center of the coaxial capacitor array 306. The threaded pipe 344 replaces the machined central mandrel 336 described with respect to FIGS. 10B and 10C. In the implementation shown in FIG. 10D, the outer busbars 332A-332F described with respect to FIGS. 10B and 10C are eliminated. Instead, outermost tin ribbons 338A-338F of adjacent rows 306A-306F may be soldered directly together to form outer electrical connections between adjacent rows 306A-306F. Eliminating the outer busbars 332A-332F and replacing the machined central mandrel with the threaded pipe 344 reduces the material cost and machining complexity of the coaxial capacitor array 306.

Mechanical support between the threaded pipe 344 and the rows 306A-306F of film capacitor rolls is provided by a socket bracket 346. The socket bracket 346 can be an additive manufacturing component (e.g., a 3D-printed component) that slides over the threaded pipe 344 and supports the concentric arrangement of the rows 306A-306F relative to the threaded pipe 344. A collector ring (not shown in FIG. 10D) can be included as a separate assembly and can include a band that connects the outer electrical connections to a common voltage node, similar in function to the collector ring 334 described with respect to FIG. 10B.

Despite the elimination of the outer busbars and the substitution of the machined central mandrel with the threaded pipe 344, the coaxial capacitor array 306 of FIG. 10D achieves substantially similar ultra-low ESL at high frequency as the implementations described with respect to FIGS. 10A-10C, due to the maintained concentric arrangement of the rows 306A-306F.

FIG. 10E depicts an alternative implementation of the coaxial capacitor array 306 that can be implemented in the cell 214, according to one or more embodiments of the present disclosure. FIG. 10E includes an end view, a perspective view, and a view of an individual capacitor 348. The coaxial capacitor array 306 of FIG. 10E includes a plurality of capacitors 348 arranged concentrically within an outer cylindrical shell 350 and around a central opening 352 to form a coaxial structure. Each capacitor 348 can have a substantially rectangular cuboid shape, which in some implementations can include rounded corners or rounded edges. In other implementations, each capacitor 348 can have other prismatic shapes that facilitate tiling around the central opening 352 with reduced interstitial gaps relative to cylindrical geometries. In one example, the capacitors 348 can include PET film or polytherimide (ULTEM) dielectric material, similar to the film capacitor rolls described with respect to FIGS. 10A-10D.

In contrast to the cylindrical film capacitor rolls described with respect to FIGS. 10A-10D, the capacitors 348 can tile around an annular space between the outer cylindrical shell 350 and the central opening 352 with reduced interstitial gaps, thereby improving volumetric efficiency and increasing energy density of the coaxial capacitor array 306. Each capacitor 348 includes an outer face that conforms to an inner surface of the outer cylindrical shell 350 and an inner face that conforms to the central opening 352. In the implementation shown in FIG. 10E, the capacitors 348 are arranged in a single concentric ring around the central opening 352. In other implementations, the capacitors 348 can be arranged in multiple concentric rings, similar to the multiple rows 306A-306F described with respect to FIGS. 10A-10D, to increase cumulative capacitance and accommodate various power conversion requirements. The central opening 352 can receive a central mandrel 336 or a threaded pipe 344 as described with respect to FIGS. 10C and 10D, respectively. In some implementations, the outer cylindrical shell 350 can function as an outer busbar for the coaxial capacitor array 306. Due to the concentric arrangement of the capacitors 348, opposing currents in the central opening 352 and the outer cylindrical shell 350 produce magnetic fields that substantially cancel, resulting in ultra-low ESL at high frequency, similar to the implementations described with respect to FIGS. 10A-10D.

Similar to MV cables, the power converter 110 can be passively cooled, allowing the cell 214 and any additional cells to be implemented without the need for additional cooling infrastructure (e.g., pumps, radiators, fans, etc.), which increases overall system reliability. In particular, the coaxial cell 214 further includes an axial heat pipe array 308 (see FIG. 3) and an axial heat pipe array 328 (see FIG. 3) for passive cooling. The axial heat pipe array 308 is arranged axially (along longitudinal axis X) from the coaxial semiconductor package 320 and toward the input end 304, and the axial heat pipe array 328 is arranged axially (along longitudinal axis X) from the coaxial semiconductor package 320 and toward the output end 394. Each of the axial heat pipe arrays 308 and 328 include multiple heat pipes that are arranged concentrically and extend longitudinally along longitudinal axis X. The axial heat pipe arrays 308 and 328 are configured to dissipate heat caused by operation of the cell 214 in the axial direction along longitudinal axis X. For example, the axial heat pipe arrays 308 and 328 can efficiently dissipate heat generated by the coaxial semiconductor package 320 along the axial direction to achieve a uniform case temperature.

Each of the axial heat pipe arrays 308 and/or 328 can be configured as a combined electrical and thermal bus. In other words, the axial heat pipe arrays 308 and 328 can distribute heat between components of the cell 214 but can also be configured to carry current between the components. For example, the axial heat pipe array 328 can transfer current between the coaxial semiconductor package 320, the second coaxial capacitor array 326, and/or the coaxial inductor module 330. The axial heat pipe arrays 308 and 328 in conjunction with the cooling structure 212 enables the power converter 110 to be passively cooled, furthering efficiency of operation.

The coaxial inductor module 330 is a coaxial solenoidal inductor module and includes a nested structure of inductors, similar to the coaxial semiconductor package 320B. Specifically, the coaxial inductor module 330 includes a first inductor module and a second inductor module, where the first inductor module is nested in the second inductor module. The coaxial inductor module 330 includes solenoidal windings enclosed by low-loss ferrite cores that are shaped to conform to the coaxial geometry of the power converter 110.

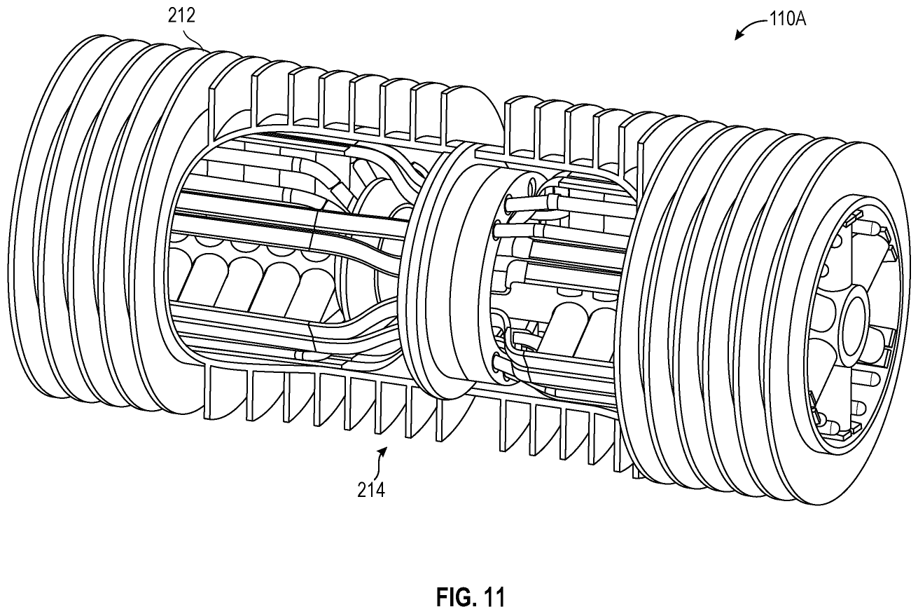

FIG. 11 depicts a portion of the power converter 110, and FIG. 12 depicts a portion of the cooling structure 212, according to one or more embodiments of the present disclosure. Portion 110A is representative of the power converter 110 that encloses the cell 214. As discussed previously, the cell 214 and its components are potted inside the cooling structure 212 with high thermal-k potting, thereby being passively cooled and insulated electrically. The cooling structure 212 is designed to increase the surface area of the power converter 110, increasing the total heat rejection from free convection. The fin structure of the cooling structure 212 can be based on commercial fin tubes used in liquid-to-air heat exchangers in chemical processing applications.

Portion 212A is a radial fin structure with stamped aluminum fins. In one example, the portion 212A has stamped 20-gauge aluminum fins measuring 28 cm outer diameter (OD) as represented by bidirectional arrows A and B, 15 cm inner diameter (ID) represented by bidirectional arrow A, and a length of 15 cm represented by bidirectional arrow C. Additionally, each fin is spaced 1.2 cm apart. In various experiments and use cases, the cooling structure 212 demonstrated a dissipation of 280 W without exceeding a case temperature of 100° C., which translates to 1400 W per meter of length. Typical underground vaults can be as large as 9 m, allowing a theoretical maximum heat dissipation of 12.6 kW per cable in a typical vault.

FIG. 13A depicts a cell-level schematic of a cell implemented in a coaxial power converter, and FIG. 13B depicts an overlayed schematic including the cell-level schematic overlayed with a circuit schematic, according to one or more embodiments of the present disclosure. Schematic 700 is representative of the cell 214 implemented in the power converter 110 and illustrates the representative coaxial structures of each of the components, such as the first coaxial capacitor array 306, the coaxial semiconductor package 320 (e.g., the coaxial semiconductor package 320B), the second coaxial capacitor array 326, the coaxial inductor module 330, and an output capacitor 740. The nested structure of the coaxial semiconductor package 320B is illustrated with the input-side transistor module 545 and the output-side transistor module 550. Additionally, the nested structure of the coaxial inductor module 330 is also illustrated with a first inductor module 330A and a second inductor module 330B, where the first inductor module 330A is nested in the second inductor module 330B. Overlayed schematic 703 depicts the circuit components of the first coaxial capacitor array 306, the coaxial semiconductor package 320, the second coaxial capacitor array 326, the coaxial inductor module 330, and the output capacitor 740 and also illustrates the electrical connections between the components.

The power converter 110 can be configured to operate as an isolated Ćuk (iSCuk) converter based on connection of the components of the cell 214 described above. The iSCuk converter is implemented due to its effective management of parasitic components. Specifically, the converter naturally absorbs input-port parasitics LMv into input inductor La, decouples output-port parasitics LLv through the output capacitor Co, and confines the commutation loop parasitics to within each cell. Additionally, to further reduce voltage spikes in the switches, the iSCuk converter is configured to allow negative inductor currents, which facilitate zero-voltage switching (ZVS) turn-on of the active switch Qa.

To best integrate the power conversion cells (e.g., the cell 214) with the cables 202 and 292, each component of the cell is designed to mimic the coaxial structure of the cables 202 and/or 292, which, theoretically, minimizes disruptions to the E-field pattern and thus minimizes the need for additional field grading and electrical insulation structures. The schematic 703 shown in FIG. 13B depicts an example integration strategy for the iSCuk topology. The highest voltage components are located near the center of the cell 214, and the lowest voltage components are located in the outer or peripheral areas of the cell 214. The voltage of the cell 214 is graded radially, similar to an MV cable. The iSCuk topology is integrated for the cell 214 for its ability to be integrated coaxially without overlapping traces that break the axial symmetry of the structure. Further description regarding the circuit topology corresponding to the cell 214 can be found in APPENDIX B of U.S. Provisional Application No. 63/711,846, and cell 214 can incorporate the circuit topology shown and described in APPENDIX B of U.S. Provisional Application No. 63/711,846.

The design of the cell 214 can be implemented based on the notion that the coaxial structure is created by revolving the schematic around an axis of symmetry, as indicated by a dotted line intersecting the center of the schematics 700 and 703. Additionally, scalable voltages were prioritized in the radial direction with the notion that constant voltages may not benefit from coax. It was determined that constant voltages (axial) became less influential as radial voltage scaled, and axial voltages locally perturb the field. Additional changes in the coaxial structures (Ro, Ri) were determined.

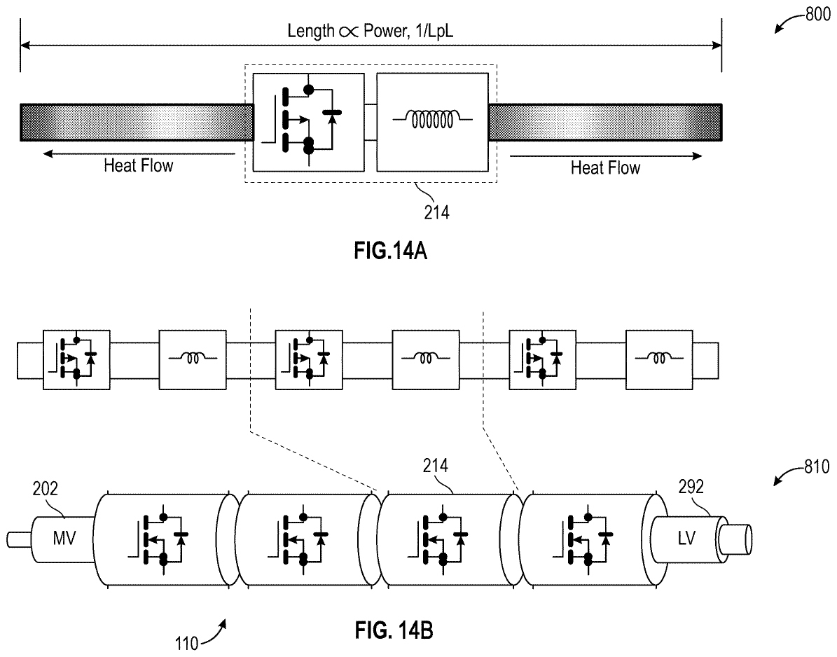

FIG. 14A depicts a heat flow distribution from a cell of a coaxial power converter, and FIG. 14B depicts a cascaded cell schematic of a coaxial power converter, according to one or more embodiments of the present disclosure. Passive cooling can impose a limit on the allowed loss-per-length (generally environmentally driven) of the power converter 110. Thus, high-loss components (e.g., switches/magnetics) are required to be uniformly distributed axially. However, a cascaded cell can introduce trade-offs. For example, a cascaded cell compared to a single cell would result in an overall longer cell that can generate more power but also more heat.

As depicted in FIG. 14A, heat flow distribution 800 depicts the heat flow distribution originating from the cell 214. During use or operation, heat generated from the cell 214 can be distributed axially in the direction depicted. As discussed previously, heat generated from the cell 214 can be dissipated axially via the axial heat pipe arrays 308 and 328 and also the cooling structure 212. Overall, to process more power, more heat is generated. This heat needs to be distributed down the length of the cable. The solution according to aspects of the embodiments is to distribute the components along the length of the cable. This way, power can be increased with more components distributed over a larger length, allowing power to be scaled infinitely with length without being limited by the axial heat spreading.

As depicted in FIG. 14B, coaxial power converter 810 (“power converter 810”) is representative of an implementation of the power converter 110 with cascaded cells. The coaxial power converter 810 includes 4 cells that are physically and electrically connected between the input cable 202 and the output cable 292. The cell 214 is representative of each cell and each cell includes substantially similar or identical components. The cascaded cells are cascaded and can be representative of a singular cascaded cell structure. The cascaded cells are modular and each cell can be removed based on application of the power converter 110. For example, for reduced power conversion requirements, one or more cells can be removed from the coaxial power converter 810. In another example, for increased power conversion requirements, one or more cells can be added to the coaxial power converter 810. The easy addition or removal of the cells enables the power converter 810 to be modular and power-scalable depending on the needs of various loads that can be connected to the power converter 810. The power converter 810 incorporates a serial-input parallel-output architecture where voltage is gradually reduced down the length of the cable. The iSCuk topology that can be implemented for the power converter 810 is tolerant of input/output parasitics, provides a self-contained commutation loop, and can be integrated in a 2D structure.

FIGS. 14A and 14B illustrate the power scaling problem associated with power electronics embedded in cables. To process more power, more heat is generated. This heat needs to be distributed down the length of the cable. There can be a fundamental limit to how much heat can be distributed and thus there is a limit to the amount of power that can be processed. The solution can then be to distribute the components along the length of the cable as shown in FIGS. 14A and 14B. This way, power can be increased with more components distributed over a larger length, allowing power to be scaled infinitely with length without being limited by the axial heat spreading.

The coaxial power converters of the embodiments can be integrated with various cables such as MV cables, enabling their use where MV cables are used. MV cables have properties that are desirable in power electronics such as benefits of cable-like structures. The coaxial power converters of the embodiments adopt these properties to encompass a cable-integrated converter. The modularity and power scalability of the coaxial power converters enable easy applicability to a wide range of power applications. Additionally, the coaxial power converters offer conversion of DC to DC, AC to DC, DC to AC, and AC to AC voltages for step-down and/or step-up, again enabling use with a wide range of power applications.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc., unless otherwise specified in the appended claims. If a component is described as having “one or more” of the component, it is understood that the component can be referred to as “at least one” component.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A coaxial capacitor array, comprising:
a plurality of capacitors arranged in at least one concentric ring around a longitudinal axis;
an inner conductive element positioned at a center of the at least one concentric ring and electrically connected to first terminals of the plurality of capacitors; and
an outer conductive element positioned around an outer periphery of the at least one concentric ring and electrically connected to second terminals of the plurality of capacitors.

2. The coaxial capacitor array of claim 1, wherein the plurality of capacitors comprises cylindrical film capacitor rolls.

3. The coaxial capacitor array of claim 1, wherein the plurality of capacitors comprises rectangular capacitors, wherein an outer face of each rectangular capacitor conforms to a curvature of the outer conductive element.

4. The coaxial capacitor array of claim 3, wherein an inner face of each rectangular capacitor conforms to a curvature of the inner conductive element.

5. The coaxial capacitor array of claim 1, wherein the plurality of capacitors comprises polyethylene terephthalate (PET) film capacitors or polytherimide capacitors.

6. The coaxial capacitor array of claim 1, wherein the plurality of capacitors are arranged in a plurality of rows around the longitudinal axis, each row comprising multiple capacitors, and wherein the plurality of rows collectively form the at least one concentric ring.

7. The coaxial capacitor array of claim 6, wherein the outer conductive element comprises a plurality of outer busbars, each outer busbar corresponding to a respective row of the plurality of rows.

8. The coaxial capacitor array of claim 7, further comprising a collector ring electrically connecting the plurality of outer busbars to a common voltage node.

9. The coaxial capacitor array of claim 1, wherein the plurality of capacitors are bonded to the inner conductive element and the outer conductive element via a rigid mechanical bonding process, wherein the coaxial capacitor array forms a unitary rigid structure.

10. The coaxial capacitor array of claim 1, further comprising a plurality of ribbons, each ribbon electrically connected to a respective terminal of a capacitor of the plurality of capacitors and secured to the inner conductive element or the outer conductive element.

11. The coaxial capacitor array of claim 10, wherein the plurality of ribbons mechanically decouple forces applied to the coaxial capacitor array from coupling into the plurality of capacitors.

12. The coaxial capacitor array of claim 10, wherein outermost ribbons of adjacent capacitors are electrically connected together to form the outer conductive element.

13. The coaxial capacitor array of claim 1, wherein the inner conductive element comprises a machined central mandrel.

14. The coaxial capacitor array of claim 1, wherein the inner conductive element comprises a threaded pipe.

15. The coaxial capacitor array of claim 14, further comprising a socket bracket positioned around the threaded pipe and providing mechanical support for the at least one concentric ring.

16. The coaxial capacitor array of claim 1, further comprising a potted bushing providing mechanical support between the inner conductive element and the outer conductive element.

17. The coaxial capacitor array of claim 1, wherein the outer conductive element comprises an outer cylindrical shell surrounding the at least one concentric ring.

18. The coaxial capacitor array of claim 1, further comprising a plurality of heat pipes embedded in the outer conductive element and extending axially along the longitudinal axis.

19. The coaxial capacitor array of claim 1, wherein:
the coaxial capacitor array is a first coaxial capacitor array coupled along the longitudinal axis to a coaxial semiconductor package;
the coaxial semiconductor package is coupled along the longitudinal axis to a second coaxial capacitor array; and
a coaxial inductor module is coupled along the longitudinal axis to the second coaxial capacitor array.

20. The coaxial capacitor array of claim 19, wherein the first coaxial capacitor array, the coaxial semiconductor package, the second coaxial capacitor array, and the coaxial inductor module are coaxially aligned along the longitudinal axis and collectively form a coaxial cell of a power converter.
